(19) United States
(12) Patent Application Publication
(10) Pub. No.: US 2008/0258338 A1
(43) Pub. Date: Oct. 23, 2008

(54) POLYCARBONATE MOLDING COMPOSITIONS

(76) Inventors: Andreas Seidel, Dormagen (DE); Eckhard Wenz, Koln (DE); Manfred Nawroth, Wipperfurth (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 12/057,554

(22) Filed: Mar. 28, 2008

(30) Foreign Application Priority Data
Apr. 5, 2007 (DE) DE 102007016786.7

(51) Int. Cl. B29C 45/16; C08K 3/34; C08K 5/09; C08K 5/42; C08K 5/55; C08K 5/5317; C08K 5/092

(52) U.S. Cl. 264/255; 524/451; 524/444; 524/284; 524/157; 524/130; 524/183; 524/321; 524/296

(57) ABSTRACT

The invention relates to talcum-reinforced polycarbonate compositions comprising: A) a polycarbonate, polyester carbonate or a mixture thereof, B) optionally, at least one polymer selected from one of the group consisting of graft polymer produced in an emulsion polymerisation process, graft polymer produced in a bulk polymerisation process, rubber-free vinyl homopolymer and rubber-free vinyl copolymer, C) talcum, D) a Brönstedt acid, and optionally E) at least one polymer additive, and wherein the composition is free of aromatic or partially aromatic polyesters. Compared to the known prior art the inventive compositions have an improved ductility, thermal resistance towards deformation and thermal stability during compounding and processing (molding). The invention also provides for the use of the composition for the production of molded articles and two-component structural parts.

### CROSS REFERENCE TO RELATED APPLICATION

This application claims priority to German Patent Application No. 102007016786, filed Apr. 5, 1007, the content of which is incorporated herein by reference in its entirety.

### BACKGROUND OF THE INVENTION

1. Field of the Invention

The present invention relates generally to talcum-reinforced polycarbonate compositions which, compared to the prior art, have an improved ductility, thermal resistance and/or thermal stability during compounding and processing (molding), as well as their use for the production of molded articles. The invention also provides low-distortion, dimensionally stable, low-stress and/or ductile molded parts capable of being produced in a two-component injection molding process, in which a transparent or translucent polycarbonate molding composition as first component has been completely or partially back-injection molded with a talcum-reinforced polycarbonate composition of high thermal stability as second component, resulting in a stable material bonding of the second component to the first component.

2. Description of Related Art

EP-A 0 391 413 discloses impact resistance-modified polycarbonate compositions which are characterised by a reduced coefficient of thermal expansion, a high low-temperature ductility, and good thermal stability. The disclosed compositions contain 40 to 80 wt. % of polycarbonate and 4 to 18 wt. % of a mineral filler with platelet-shaped particle geometry, for example special types of talcum. The use of an acid as an additive is not disclosed in this application.

EP-A 0 452 788 discloses talcum-filled impact resistance-modified polycarbonate compositions for the production of molded parts having good mechanical properties and reduced surface gloss, which contain 10 to 80 parts by weight of polycarbonate, 90 to 20 parts by weight of ABS and 2 to 25 parts by weight, referred to the sum of polycarbonate and ABS, of talcum with a mean particle size of 1.5 to 20 μm. The use of an acid as an additive is not disclosed in this application.

WO 98/51737 discloses mineral-filled, impact resistance-modified polycarbonate compositions with improved thermal stability, low-temperature toughness, dimensional stability and melt flowability, which contain 65 to 85 parts by weight of polycarbonate, 10 to 50 parts by weight of ABS and 1 to 15 parts by weight of particular mineral filler (e.g. talcum) with a mean largest particle expansion of 0.1 to 30 μm. The use of an acid as an additive is not disclosed in this application.

WO-A 99/28386 discloses compositions containing polycarbonate, graft polymer based on an elastomer with a glass transition temperature of below 110° C., copolymer, filler (e.g. talcum) and a low molecular weight, halogen-free acid, characterised in that these compositions contain at least one aromatic or partially aromatic polyester, or a mixture thereof. The compositions have improved mechanical properties (e.g. elongation at break) and an improved melt flowability.

### SUMMARY OF THE INVENTION

An object of the present invention was to provide a polycarbonate composition with improved ductility, thermal resistance as well as with an improved thermal stability in both the compounding and processing (shaping) of a molding composition. It was surprisingly found that a composition comprising the following components unexpectedly fulfilled one or more objects of the present invention:
A) 10 to 100 parts by weight, based on the total weight of components A and B, of polycarbonate, polyester carbonate or a mixture thereof,
B) 0 to 90 parts by weight, based on the total weight of components A and B, of a polymer which is at least one selected from the group consisting of graft polymer produced in an emulsion polymerisation process, graft polymer produced in a bulk polymerisation process, rubber-free vinyl homopolymer and rubber-free vinyl copolymer,
C) 7 to 30 wt. %, based on the total weight of the composition of talcum,
D) 0.01 to 1 wt. %, based on the total weight of the composition of a Brönstedt acid,
E) 0 to 20 wt. %, based on the total weight of the composition of at least one polymer additive,
wherein the composition is free of aromatic or partially aromatic polyesters,
wherein the sum of the wt. % of the components A and B in the total composition is calculated from the difference of 100 wt. % minus the sum of the wt. % of the components C, D and E, and
wherein the total composition comprises the sum of the wt. % of components A+B+C+D+E.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### DETAILED DESCRIPTION OF A PREFERRED EMBODIMENT

A further object of a preferred embodiment of the invention is, when processing talcum-filled polycarbonate compositions, to avoid the tendency to form processing streaks on the surface of molded articles produced in an injection molding process.

It was surprisingly found that this additional object can be achieved, for example, by employing a composition according to the invention mentioned above, if these contain as component D at least one acid, which
D1) is thermally stable and is not volatile under conditions of compounding and processing of the compositions according to the invention (that is, at temperatures of 200° to 320° C., preferably 240° to 300° C.), or
D2) decomposes under the thermal conditions of the compounding (that is at temperatures of 2000 to 320° C., preferably 240° to 300° C.), but that all decomposition products formed either (i) are thermally stable themselves at temperatures from 200° C. to 320° C., preferably 240° to 300° C. or (ii) have a boiling point below 150C. Namely, if the acid D decomposes between the temperatures of 200° C. and 320° C., preferably 240° to 300° C., there are two options. First, in the case of an acid called component D2.1), two types of decomposition products are formed, (i) on the one hand, decomposition products that are thermally stable and not volatile under compounding conditions, and (ii) on the other hand, decomposition products which have a boiling point below 150° C. Second, in the case of acids according to component D2.2) these types of acids exclusively form decomposition products that have a boiling point below 150° C. Note that for any decomposition products that have a boiling point below 150° C., these products can be removed by vacuum degassing of the composition.

This preferred embodiment is the subject of sub-claims.

### Component A

Aromatic polycarbonates and/or aromatic polyester carbonates of component A that are suitable according to the invention include any desired material. Suitable materials for component A are known in the literature and/or can be produced by processes known in the literature (for the production of aromatic polycarbonates, see for example Schnell, “Chemistry and Physics of Polycarbonates”, Interscience Publishers, 1964, and also DE-AS 1 495 626, DE-A 2 232 877, DE-A 2 703 376, DE-A 2 714 544, DE-A 3 000 610, DE-A 3 832 396; for the production of aromatic polyester carbonates, see for example DE-A 3 077 934), the contents of each are incorporated herein by reference in their entireties.

The production of an aromatic polycarbonate can be carried out for example by reacting diphenols with carbonic acid halides, preferably phosgene and/or with aromatic dicarboxylic acid dihalides, preferably benzenedicarboxylic acid dihalides, by the interfacial polymerisation process, optionally with the use of chain terminators, for example monophenols, and optionally with the use of trifunctional or higher functional branching agents, for example triphenols or tetraphenols. A production of aromatic polycarbonates by a melt polymerisation process by reacting diphenols with for example diphenyl carbonate is also possible.

Diphenols for the production of the aromatic polycarbonates and/or aromatic polyester carbonates are preferably those of the formula (I)

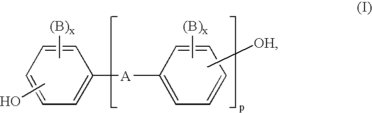

wherein
A denotes a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, onto which further aromatic rings optionally containing heteroatoms can be condensed,
   or a radical of the formula (II) or (III)

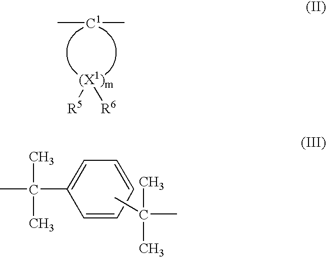

B denotes in each case C₁ to C₁₂-alkyl, preferably methyl, halogen, preferably chorine and/or bromine,
x is in each case independently of one another 0, 1 or 2,
p is 1 or 0, and
R⁵ and R⁶ denote for each X¹, individually selectable and independently of one another, hydrogen or C₁ to C₆-alkyl, preferably hydrogen, methyl or ethyl,
X¹ denotes carbon, and
m is a whole number from 4 to 7, preferably 4 or 5, with the proviso that on at least one atom X¹, R¹ and R⁶ are simultaneously alkyl.

Preferred diphenols are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)-ethers, bis-(hydroxyphenyl)-sulfoxides, bis-(hydroxyphenyl)-ketones, bis-(hydroxyphenyl)-sulfones and α,α-bis-(hydroxyphenyl)-diisopropylbenzenes, as well as their nuclear-brominated and/or nuclear-chlorinated derivatives.

Particularly preferred diphenols are 4,4′-dihydroxydiphenyl, bisphenol A, 2,4-bis(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenyl sulfone as well as their dibrominated and tetrabrominated or chlorinated derivatives, such as for example 2,2-bis(3-chloro-4-hydroxyphenyl)-propane, 2,2-bis-(3,5-dichlor-4-hydroxyphenyl)-propane or 2,2-bis-(3,5-dibromo-4-hydroxyphenyl)-propane. 2,2-bis(4-hydroxyphenyl)-propane (bisphenol A) is particularly preferred.

The diphenols can be used individually or as arbitrary mixtures. Any diphenol can be employed and suitable diphenols are known in the art and/or can be obtained by any process including those known in the literature.

For the production of the thermoplastic, aromatic polycarbonates, suitable chain terminators are for example phenol, p-chlorophenol, p-tert.-butylphenol or 2,4,6-tribromophenol, and also long-chain alkylphenols, such as 4-[2-(2,4,4-trimethylpentyl)]-phenol, 4-(1,3-tetramethylbutyl)-phenol according to DE-A 2 842 005 or monoalkylphenol or dialkylphenols with a total of 8 to 20 carbon atoms in the alkyl substituents, such as 3,5-di-tert.-butylphenol, p-iso-octylphenol, p-tert.-octylphenol, p-dodecylphenol, and 2-(3,5-dimethylheptyl)-phenol and 4-(3,5-dimethylheptyl)-phenol. The amount of chain terminators to be used is in general between 0.5 mole % and 10 mole %, referred to the mole sum of the diphenols used in each case.

The thermoplastic, aromatic polycarbonates have mean weight-average molecular weights (M_{w}, measured for example by GPC, ultracentrifugation or scattered light measurements) of 10,000 to 200,000 g/mole, preferably 15,000 to 80,000 g/mole, particularly preferably 24,000 to 32,000 g/mole.

The thermoplastic, aromatic polycarbonates can be branched in a known manner, and more particularly preferably by the incorporation of 0.05 to 2.0 mole %, referred to the sum of the employed diphenols, of trifunctional or higher functional compounds, for example those with three and more phenolic groups.

Both homopolycarbonates and copolycarbonates are suitable. For the production of copolycarbonates of component A according to the invention, 1 to 25 wt. %, preferably 2.5 to 25 wt. % referred to the total amount of diphenols employed, of poly-diorganosiloxanes with hydroxyaryloxy terminal groups can also be used. These are known, for example in U.S. Pat. No. 3,419,634 and can be produced by methods known in the literature. The production of polydiorganosiloxane-containing copolycarbonates is described, for example, in DE-A 3 334 782. The contents of each of these documents are incorporated herein by reference in their entireties.

Preferred polycarbonates are, in addition to the bisphenol A homopolycarbonates, also the copolycarbonates of bisphenol A with up to 15 mole %, referred to the mole sums of diphenols, of diphenols other than those mentioned as preferred or particularly preferred, in particular 2,2-bis(3,5-dibromo-4-hydroxyphenyl)-propane.

Aromatic dicarboxylic acid dihalides for the production of aromatic polyester carbonates are preferably the diacid dichlorides of isophthalic acid, terephthalic acid, diphenyl ether-4,4′-dicarboxylic acid and naphthalene-2,6-dicarboxylic acid.

Particularly preferred are mixtures of the diacid dichlorides of isophthalic acid and of terephthalic acid in a ratio between 1:20 and 20:1.

In the production of polyester carbonates a carbonic acid halide, preferably phosgene, is additionally co-used as bifunctional acid derivative.

Suitable chain terminators for the production of the aromatic polyester carbonates are, apart from the already mentioned monophenols, also their chlorocarbonic acid esters as well as the acid chlorides of aromatic monocarboxylic acids, which can optionally be substituted by C₁ to C₂₂-alkyl groups or by halogen atoms, as well as aliphatic C₂ to C₂₂-monocarboxylic acid chlorides.

The amount of chain terminators is in each case 0.1 to 10 mole %, referred in the case of the phenolic chain terminators to moles of diphenol, and in the case of monocarboxylic acid chloride chain terminators, to moles of dicarboxylic acid dichloride.

The aromatic polyester carbonates can also contain aromatic hydroxycarboxylic acids in incorporated form.

The aromatic polyester carbonates can be branched linearly as well as in a known manner (see in this connection DE-A 2 940 024 and DE-A 3 007 934, the contents of each are incorporated herein by reference in their entireties).

Suitable branching agents include for example trifunctional or higher functional carboxylic acid chlorides, such as trimesic acid trichloride, cyanuric acid trichloride, 3,3′,4,4′-benzophenonetetracarboxylic acid tetrachloride, 1,4,5,8-naphthalenetetracarboxylic acid tetrachloride or pyromellitic acid tetrachloride, in amounts of 0.01 to 1.0 mole % (referred to employed dicarboxylic acid dichlorides), or trifunctional or higher functional phenols such as phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis-(4-hydroxyphenyl)cyclohexyl]-propane, 2,4-bis-(4-hydroxyphenylisopropyl)-phenol, tetra-(4-hydroxyphenyl)-methane, 2,6-bis-(2-hydroxy-5-methylbenzyl)-4-methylphenol, 2-(4-hydroxyphenyl)-2-(2,4-dihydroxyphenyl)-propane, tetra-(4-[4-hydroxyphenyl-isopropyl]-phenoxy)-methane, 1,4-bis-[4,4′-dihydroxytriphenyl)methyl]-benzene, in amounts of 0.01 to 1.0 mole %, referred to employed diphenols. Phenolic branching agents can be used with the diphenols, and acid chloride branching agents can be added together with the acid dichlorides.

The proportion of carbonate structural units can vary arbitrarily in the thermoplastic, aromatic polyester carbonates. Preferably the proportion of carbonate groups is up to 100 mole %, in particular up to 80 mole %, particularly preferably up to 50 mole %, referred to the sum total of ester groups and carbonate groups. Both the ester proportion and the carbonate proportion of the aromatic polyester carbonates can be present in the form of blocks or randomly distributed in the polycondensate.

The relative solution viscosity (ηᵣₑₗ) of the aromatic polycarbonates and polyester carbonates is in the range from 1.18 to 1.4, preferably 1.20 to 1.32 (measured in solutions of 0.5 g polycarbonate or polyester carbonate in 100 ml methylene chloride solution at 25° C.).

The thermoplastic, aromatic polycarbonates and polyester carbonates can be used alone or in arbitrary mixtures.

### Component B

The component B is selected from at least one member of the group of graft polymers B.1 or of rubber-free (co)polymers B.2.

The component B.1 includes one or more graft polymers of
B.1.1 5 to 95 wt. %, preferably 30 to 90 wt. %, of at least one vinyl monomer on
B.1.2 95 to 5 wt. %, preferably 70 to 10 wt. %, of one or more graft bases with glass transition temperatures <10° C., preferably <0° C., particularly preferably <−20° C.

The graft base B.1.2 has in general a mean particle size (d₅₀ value) of 0.05 to 10 μm, preferably 0.1 to 5 μm, particularly preferably 0.15 to 2.0 μm.

Monomers B.1.1 are preferably mixtures of
B1.1.1 50 to 99 parts by weight of vinyl aromatic compounds and/or nuclear-substituted vinyl aromatic compounds (such as styrene, α-methylstyrene, p-methylstyrene, p-chlorostyrene) and/or methacrylic acid —(C₁-C₈)-alkyl esters, such as methyl methacrylate, ethyl methacrylate), and
B1.1.2.1 to 50 parts by weight of vinyl cyanides (unsaturated nitriles such as acrylonitrile and methacrylonitrile) and/or (meth)acrylic acid-(C₁-C₈)-alkyl esters, such as methyl methacrylate, n-butyl acrylate, t-butyl acrylate, and/or derivatives (such as anhydrides and imides) of unsaturated carboxylic acids, for example maleic anhydride and N-phenyl maleimide.

Preferred monomers B.1.1.1 are selected from at least one of the monomers styrene, α-methylstyrene and methyl methacrylate, and preferred monomers B.1.1.2 are selected from at least one of the monomers acrylonitrile, maleic anhydride and methyl methacrylate. Particularly preferred monomers are B.1.1.1 styrene and B1.1.2 acrylonitrile.

For the graft polymers B.1, suitable graft bases B.1.2 are for example diene rubbers, EP(D)M rubbers, i.e. those based on ethylene/propylene and optionally diene, acrylate, polyurethane, silicone, chloroprene and ethylene/vinyl acetate rubbers, and also silicone/acrylate composite rubbers.

Preferred graft bases B.1.2 are diene rubbers, for example based on butadiene and isoprene, or mixtures of diene rubbers or copolymers of diene rubbers or their mixtures with further copolymerisable monomers (for example according to B.1.1.1 and B.1.1.2), with the proviso that the glass transition temperature of the component B.2 is below 10° C., preferably <0° C., particularly preferably <−20° C. Pure polybutadiene rubber is particularly preferred.

Particularly preferred polymers B.1 are for example ABS polymers (emulsion, bulk and suspension ABS), such as are described for example in DE-OS 2 035 390 (=US-PS 3 644 574) or in DE-OS 2 248 242 (=GB-PS 1 409 275) and in Ullmanns, Enzyklopädie der Technischen Chemie, Vol. 19 (1980), pp. 280 ff, the contents of each are incorporated herein by reference in their entireties.

The graft copolymers B.1 are produced by free-radical polymerisation, for example by emulsion, suspension, solution or bulk polymerisation, preferably by emulsion or bulk polymerisation, particularly preferably by emulsion polymerisation.

The gel fraction of the graft base B.1.2 in graft polymers produced by emulsion polymerisation is at least 30 wt. %, preferably at least 40 wt. % (measured in toluene).

The gel fraction of graft polymers B.1 produced by bulk polymerisation is preferably 10 to 50 wt. %, in particular 15 to 40 wt. % (measured in acetone).

Particularly suitable graft rubbers are also ABS polymers, which are produced by redox initiation with an initiator system consisting of organic hydroperoxide and ascorbic acid according to U.S. Pat. No. 4,937,285, the content of which is incorporated herein by reference in its entirety.

Since in the grafting reaction the graft monomers are, as is known, not necessarily completely grafted onto the graft base, according to the invention graft polymers B.1 are also understood to include those polymers that are obtained by (co)polymerisation of the graft monomers in the presence of the graft base and occur in the working-up. These products can therefore also contain free, i.e. not chemically bound to the rubber, (co)polymer of the graft monomers.

In the case of graft polymers B.1 that have been produced by a bulk polymerisation process, the weight average molecular weight M_{w} of the free, i.e. not bound to the rubber, (co)polymer is 50,000 to 250,000 g/mole, in particular 60,000 to 180,000 g/mole, particularly preferably 70,000 to 130,000 g/mole.

Suitable acrylate rubbers according to B.1.2 are preferably polymers of acrylic acid alkyl esters, optionally with up to 40 wt. %, referred to B.1.2, of other polymerisable, ethylenically unsaturated monomers. Preferred polymerisable acrylic acid esters include C₁ to C₈-alkyl esters, for example methyl, ethyl, butyl, n-octyl and 2-ethylhexyl esters; halogenated alkyl esters, preferably halogen-C₁-C₈-alkyl esters, such as chloroethyl acrylate, as well as mixtures of these monomers.

For the crosslinking, monomers with more than one polymerisable double bond can be copolymerised. Preferred examples of crosslinking monomers are esters of unsaturated monocarboxylic acids with 3 to 8 C atoms and unsaturated monohydric alcohols with 3 to 12 C atoms, or saturated polyols with 2 to 4 OH groups and 2 to 20 C atoms, such as ethylene glycol dimethacrylate, allyl methacrylate, polyunsaturated heterocyclic compounds, such as trivinyl cyanurate and triallyl cyanurate; polyfunctional vinyl compounds, such as divinylbenzene and trivinylbenzene; and also triallyl phosphate and diallyl phthalate. Preferred crosslinking monomers are allyl methacrylate, ethylene glycol dimethacrylate, diallyl phthalate and heterocyclic compounds that contain at least three ethylenically unsaturated groups. Particularly preferred crosslinking monomers are the cyclic monomers triallyl cyanurate, triallyl isocyanurate, triacryloylhexahydro-s-triazine, triallylbenzenes. The amount of crosslinked monomers is preferably 0.02 to 5 wt. %, in particular 0.05 to 2 wt. %, referred to the graft base B.1.2. In the case of cyclic crosslinking monomers with at least three ethylenically unsaturated groups, it is advantageous to limit the amount to below 1 wt. % of the graft base B.1.2.

Preferred “other” polymerisable, ethylenically unsaturated monomers that apart from the acrylic acid esters can optionally be used for the production of the graft base B.1.2, include for example acrylonitrile, styrene, α-methylstyrene, acrylamides, vinyl-C₁-C₆-alkyl ethers, methyl methacrylate and butadiene. Preferred acrylate rubbers as graft base B.2 are emulsion polymers that have a gel content of at least 60 wt. %.

Further suitable graft bases according to B.1.2 are silicone rubbers with graft-active sites, such as are described in DE-OS 3 704 657, DE-OS 3 704 655, DE-OS 3 631 540 and DE-OS 3 631 539, the contents of each are incorporated herein by reference in their entireties.

The gel content of the graft base B.1.2 and of the graft polymers B.1 is determined at 25° C. in a suitable solvent as the fraction insoluble in these solvents (M. Hoffman, H. Krömer, R. Kuhn, Polymeranalytik I and II, Georg Thieme-Verlag, Stuttgart 1977).

The mean particle size d₅₀ is the diameter above and below which in each case 50 wt. % of the particles lie, and can be determined by ultracentrifugation measurements (W. Scholtan, H. Lange, Kolloid, Z. and Z. Polymere 250 (1972), 782-1796), which is incorporated herein by reference in its entirety. The rubber-free vinyl (co)polymers B.2 are rubber-free homopolymers and/or copolymers of at least one monomer from the group comprising vinyl aromatic compounds, vinyl cyanides (unsaturated nitriles), (meth)acrylic acid —(C₁ to C₈)-alkyl esters, unsaturated carboxylic acids, as well as derivatives (such as anhydrides and imides) of unsaturated carboxylic acids.

Particularly suitable are (co)polymers B.2 of
B.2.1 50 to 99 wt. %, referred to the (co)polymer B.2, of at least one monomer selected from the group comprising vinyl aromatic compounds (such as for example styrene, α-methylstyrene), nuclear-substituted vinyl aromatic compounds (such as for example p-methylstyrene, p-chlorostyrene) and (meth)acrylic acid-(C₁-C₈)-alkyl esters (such as for example methyl methacrylate, n-butyl acrylate, tert.-butyl acrylate) and
B.2.2 1 to 50 wt. %, referred to the (co)polymer B.2, of at least one monomer selected from the group comprising vinyl cyanides (such as for example unsaturated nitriles such as acrylonitrile and methacrylonitrile), (meth)acrylic acid-(C₁-C₈)-alkyl esters (such as for example methyl methacrylate, n-butyl acrylate, tert.-butyl acrylate), unsaturated carboxylic acids and derivatives of unsaturated carboxylic acids (for example maleic anhydride and N-phenylmaleimide).

These (co)polymers B.2 are resin-like, thermoplastic and rubber-free. The copolymer of styrene and acrylonitrile is particularly preferred.

Such (co)polymers B.2 are known and can be produced by free-radical polymerisation, in particular by emulsion, suspension, solution or bulk polymerisation. The (co)polymers preferably have mean molecular weight M_{w} (weight average molecular weight, determined by GPC, light scattering or sedimentation) between 15,000 and 250,000.

As component B, there can be used a pure graft polymer B.1 or a mixture of several graft polymers according to B.1, a pure (co)polymer B.2, or a mixture of several (co)polymers according to B.2, or a mixture of at least one graft polymer B.1 with at least one (co)polymer B.2. If mixtures of several graft polymers, mixtures of several (co)polymers or mixtures of at least one graft polymer with at least one (co)polymer are used, then these can be employed separately in the production of the compositions according to the invention or can also be used in the form of a precompound.

In a preferred embodiment there is used as component B a pure graft polymer B.1 or a mixture of several graft polymers according to B.1 or a mixture of at least one graft polymer B.1 with at least one (co)polymer B.2.

In a particularly preferred embodiment there is used as component B an ABS graft polymer produced by emulsion polymerisation or an ABS graft polymer produced by bulk polymerisation, or a mixture of a graft polymer produced by emulsion polymerisation and a SAN copolymer.

### Component C

Naturally occurring or synthetically produced talcum is used as component C.

Pure talcum has the chemical composition 3 MgO.4SiO₂.H₂O and thus has an MgO content of 31.9 wt. %, an SiO₂ content of 63.4 wt. % and a content of chemically bound water of 4.8 wt. %. Pure talcum is a silicate with a layer structure.

Naturally occurring talcum materials generally do not have the ideal composition given above, since they are contaminated by partial exchange of the magnesium by other elements, by partial exchange of silicon by for example aluminium, and/or by intergrowths with other minerals, such as for example dolomite, magnesite and chlorite.

Those types of talcum having a particularly high degree of purity are preferably used as component C. These are characterised by an MgO content of 28 to 35 wt. %, preferably 30 to 33 wt. %, particularly preferably 30.5 to 32 wt. %, and an SiO₂ content of 55 to 65 wt. %, preferably 58 to 64 wt. %, particularly preferably 60 to 62.5 wt. %. Particularly preferred types of talcum in some embodiments possess as low of an Al₂O₃ content as possible, for example, less than 5 wt. %, particularly preferably less than 1 wt. %, and especially less than 0.7 wt. %.

It can be advantageous in some cases to use talcum in the form of finely ground types with a mean particle diameter d₅₀ of <10 μm, preferably <5 μm, particularly preferably <2 μm, and most particularly preferably ≦1.5 μm.

The talcum can be surface-treated, for example silanized, in order to ensure a better compatibility with the polymer. As regards the processing and production of the molding compositions, it may be advantageous in some cases to use compacted talcum.

### Component D

As component D there can be used in principle all types of Brönstedt acid organic or inorganic compounds or mixtures thereof.

Preferred organic acids according to component D can advantageously be selected from at least one of the group comprising aliphatic or aromatic, optionally multifunctional carboxylic acids, sulfonic acids and phosphonic acids. Particularly preferred are aliphatic or aromatic dicarboxylic acids and hydroxy-functionalised dicarboxylic acids.

In a preferred embodiment at least one compound selected from the group consisting of benzoic acid, citric acid, oxalic acid, fumaric acid, mandelic acid, tartaric acid, terephthalic acid, isophthalic acid, p-toluenesulfonic acid is used as component D.

Preferred inorganic acids are ortho- and meta-phosphoric acids and acid salts of these acids, as well as boric acid.

In a particularly preferred embodiment there is used as component D an acid that is thermally stable and is not volatile under the conditions of the compounding and processing of the composition according to the invention, i.e. as a rule up to 200° C., preferably up to 320° C., particular preferably up to 350° C. (component D1). Preferably component D1) is terephthalic acid or acid salts of inorganic acids such as alkali metal or alkaline earth metal hydrogen phosphates and also alkali metal or alkaline earth metal dihydrogen phosphates.

In an alternative, likewise preferred embodiment, as component D those acids (component D2) are used that that decompose under the thermal conditions of the compounding (i.e. at temperatures from 200° to 320° C., preferably 240° to 300° C.),
wherein in the case of acids according to component D2.1) two types of decomposition products are formed, namely on the one hand those that are thermally stable and are also not volatile under the conditions of the compounding, and on the other hand those that have a boiling point below 150° C., and
wherein in the case of acids according to component D2.2), exclusively decomposition products are formed that have a boiling point below 150° C. and consequently are removed again in the compounding in the step involving the vacuum degassing of the composition.

Preferably component D2.1) are acids which, with the splitting-off of water, carbon monoxide and/or carbon dioxide, form as a further decomposition product, a compound that is thermally stable and is not volatile under the conditions of the compounding (200° to 320° C., preferably 240° to 300° C.), and particularly preferably component D2.1) is selected from at least one acid selected from the group consisting of ortho-phosphoric acid, meta-phosphoric acid and boric acid.

Preferably component D2.2) are acids which decompose under the conditions of the compounding (200° to 320° C., preferably 240° to 300° C.) without leaving any residue, with the splitting-off of water, carbon monoxide and/or carbon dioxide, and particularly preferably component D2.2) is oxalic acid.

### E) Further Components

The composition can contain further additives as component E. Suitable as further additives according to component E are in particular conventional polymer additives such as flameproofing agents (for example organic phosphorus-containing or halogen-containing compounds, in particular bisphenol A-based oligophosphate), antidripping agents (for example compounds of the substance classes comprising fluorinated polyolefins, silicones as well as aramide fibres), lubricants and mold-release agents, for example pentaerythritol tetrastearate, nucleating agents, antistatics, stabilisers, fillers and reinforcing substances other than talcum (for example glass fibres or carbon fibres, mica, kaolin, CaCO₃ and glass chips), as well as dyes and pigments (for example titanium dioxide or iron oxide).

The compositions according to the invention are free of aromatic or partially aromatic polyesters, such as those disclosed in WO-A 99/28386, the content of which is incorporated herein by reference in its entirety. Aromatic or partially aromatic polyesters are understood in the context of the invention as any polycarbonate that cannot be used as component A of the present invention described supra. Aromatic polyesters are typically derived from aromatic dihydroxy compounds and aromatic dicarboxylic acids or aromatic hydroxycarboxylic acids. The partially aromatic polyesters include those based on aromatic dicarboxylic acids and one or more different aliphatic dihydroxy compounds.

### Production of the Molding Compositions and Molded Articles

The thermoplastic molding compositions according to the invention can be produced for example, by mixing the respective constituents in a known manner, followed by melt compounding and melt extrusion at temperatures of 200° to 320° C., preferably 240° to 320° C., particularly advantageously 240° to 300° C., in conventional equipment such as internal kneaders, extruders and twin screw extruders.

The mixing of the individual constituents can be carried out in a known manner both successively and also simultaneously, and in particular at a temperature of about 20° C. (room temperature) as well as at higher temperatures.

In a preferred embodiment the production of the compositions according to the invention can be carried out, for example, by mixing the components A to D and optionally further components E at temperatures in the range from 200° to 320° C., preferably 240° to 320° C., particularly advantageously 240° to 300° C., and at a pressure of up to 500 mbar, preferably at most 200 mbar, in particular at most 100 mbar, in a conventional compounding unit, preferably in a twin shaft extruder.

In a preferred process for the production of the composition if the composition according to the invention that contains at least one acid according to component D2), components A to E are melted in a conventional mixing device and are mixed at a temperature of 240° to 320° C. preferably 240° to 300° C. The volatile decomposition products of the component D2) formed under these conditions are removed from the melt by applying a vacuum of p_{Abs}≦500 mbar (vacuum degassing).

The invention accordingly also provides a process for the production of a composition according to the invention.

The molding compositions according to the invention can be used for the production of any desired molded article. Such an article can be produced for example by injection molding, extrusion and/or blow molding. A further form of processing is the production of molded articles by thermoforming from previously produced sheets or films.

Examples of such molded parts include films, profiled sections, housing parts of all types, for example for domestic appliances such as juicers, coffee-making machines, mixers; for office equipment such as monitors, flat screens, notebooks, printers, copiers; sheets, tubing, electrical installation ducting, windows, doors and further profiled sections for the building and construction sector (interior fittings and external applications) as well as electrical and electronics parts such as switches, plugs and sockets, and structural parts for commercial and utility vehicles, in particular for the automobile sector. The compositions according to the invention are also suitable for the production of the following molded articles or molded parts: internal structural parts for track vehicles, ships, aircraft, buses and other vehicles, vehicle body parts, housings of electrical equipment containing small transformers, housings for information processing and transmission equipment, housings and linings of medical equipment, massage equipment and housings for the latter, children's toy vehicles, two-dimensional wall elements, housings for safety devices, thermally insulated transporting containers, molded parts for sanitaryware and bath fittings, cover gratings for ventilation openings, and sheds for garden tools.

The molding compositions according to the invention are in particular suitable for the production of low-warpage and low-stress, dimensionally stable and ductile two-component structural parts, in which a transparent or translucent polycarbonate molding composition as first component has been fully or partially back injection molded with the talcum-reinforced, impact resistance-modified polycarbonate compositions according to the invention as second component, resulting in a stable material bonding of the second component to the first component. The transparent or translucent polycarbonate molding composition used in this connection as first component preferably contains 95 to 100 wt. %, particularly preferably 98 to 100 wt. % of polycarbonate according to component A, and 0 to 5 wt. %, particularly preferably 0 to 2 wt. % of component E. These two-component structural parts can for example be a two-dimensional material composite consisting of a transparent or translucent polycarbonate layer with an opaque, impact resistance-modified polycarbonate layer, or can be a material composite consisting of a transparent or translucent surface framed by an opaque frame containing the impact resistance-modified polycarbonate composition according to the invention. Such material composites can be used for example in the window and glazing sector, in lighting units, in optical lenses of polycarbonate with an opaque frame injection molded thereon, in vehicle headlight cover discs with an opaque frame, in non-transparent decorative coverings back injection molded two dimensionally with transparent polycarbonate as high gloss layer in order to achieve a penetrative effect, in which connection an opaque impact resistance-modified, talcum-reinforced polycarbonate composition according to the invention is back injection molded with a transparent polycarbonate composition, in diaphragms in the automobile sector (for example external pillar linings), and in monitor/display covers of polycarbonate with an opaque frame.

The aforementioned two-component structural parts are preferably produced in a process in which the first component is back injection molded with the second component in an injection molding or injection compression molding process (two-component injection molding process or two-component injection compression molding process).

### EXAMPLES

### Component A

Linear polycarbonate based on bisphenol A with a weight average molecular weight M̅_{w} of ca. 28,000 g/mole (determined by GPC).

### Component B-1

ABS polymer produced by bulk polymerisation of 82 wt. %, referred to the ABS polymer, of a mixture of 24 wt. % of acrylonitrile and 76 wt. % of styrene in the presence of 18 wt. %, referred to the ABS polymer, of a polybutadiene-styrene block copolymer rubber with a styrene content of 26 wt. %. The weight average molecular weight M̅_{w} of the free SAN copolymer fraction in this ABS polymer is 80,000 g/mole (measured by GBP in THF). The gel content of the ABS polymer is 24 wt. % (measured in acetone).

### Component B-2

Graft polymer of 44 parts by weight of a copolymer of styrene and acrylonitrile in a ratio of 73:27 on 56 parts by weight of particulate crosslinked polybutadiene rubber (mean particle diameter d₅₀=0.3 μm), produced by emulsion polymerisation.

### Component B-3

SAN copolymer with an acrylonitrile content of 23 wt. % and a weight average molecular weight of about 130,000 g/mole.

### Component C

Talcum: Naintsch® A3c, Luzenac Naintsch (Graz, Austria) with a mean particle diameter d₅₀ of ca. 1.2 μm and an Al₂O₃ content of 0.4 wt. %.

### Component D-1

anhydrous citric acid (Brenntag, Duisburg, Germany)

### Component D-2

terephthalic acid (Interquisa, Spain)

### Component E-1

pentaerythritol tetrastearate

### Component E-2

### Irganox® B900 (Ciba, Basel, Switzerland)

### Component E-3

### Carbon Black Pearls 800 (Cabot, Leuven, Belgium)

### Production and Testing of the Molding Compositions According to the Invention

The mixing of the components is carried out in a ZSK-25 twin shaft extruder from Werner & Pfleiderer at a melt temperature of 260° C. and under the application of a reduced pressure of 50 mbar (absolute). The molded articles are produced at a melt temperature of 260° C. and a mold temperature of 80° C. in an Arburg 270 E type injection molding machine.

The melt flow rate (MVR) is determined according to ISO 1133 at 260° C. with a plunger load of 5 kg. An increased MVR measured in the granules indicates a breakdown of the polycarbonate molecular weight in the composition during the compounding, and is thus a measure of the thermal stability during compounding.

The change in the MVR (AMVR) measured according to ISO 1133 at 260° C. with a plunger load of 5 kg while heating for 15 minutes at 300° C. serves as a measure of the thermal processing stability of the composition.

The impact strength is measured at 23° C. according to ISO 180-IU on test pieces of size 80 mm×10 mm×4 mm. The mean value calculated from 10 individual measurements is recorded. The evaluation “n.g.” means that in at least 50% of the individual measurements the test piece did not break in the impact test.

The Vicat B/120 as a measure of the deformation resistance of the material under heat is determined according to ISO 306 on test pieces of size 80 mm×10 mm×4 mm with a plunger load of 50 N and a heating rate of 120° C.

In order to assess the tendency for processing streaks to occur, test sheets of size 60 mm×40 mm×2 mm produced by injection molding at 280° C. with a residence time of 2.5 minutes are visually evaluated.

TABLE 1
Molding compositions and their properties

| | Components [parts by wt] | | | | | | | | | | | | |
|---|---|---|---|---|---|---|---|---|---|---|---|---|---|
| | 1 | | | 4 | | 6 | | | 9 | | 11 | | |
| | (Comp.) | 2 | 3 | (Comp.) | 5 | (Comp.) | 7 | 8 | (Comp.) | 10 | (Comp.) | 12 | 13 |
| A | 90 | 90 | 90 | 86 | 86 | 83 | 83 | 83 | 77 | 77 | 70 | 70 | 70 |
| B-1 | — | — | — | 4 | 4 | 7 | 7 | 7 | 13 | 13 | 20 | 20 | 20 |
| B-2 | — | — | — | — | — | — | — | — | — | — | — | — | — |
| B-3 | — | — | — | — | — | — | — | — | — | — | — | — | — |
| C | 10 | 10 | 10 | 10 | 10 | 10 | 10 | 10 | 10 | 10 | 10 | 10 | 10 |
| D-1 | — | 0.3 | — | — | 0.3 | — | 0.3 | — | — | 0.3 | — | 0.3 | — |
| D-2 | — | — | 0.3 | — | — | — | — | 0.3 | — | — | — | — | 0.3 |
| E-1 | 0.50 | 0.50 | 0.50 | 0.50 | 0.50 | 0.50 | 0.50 | 0.50 | 0.50 | 0.50 | 0.50 | 0.50 | 0.50 |
| E-2 | 0.20 | 0.20 | 0.20 | 0.20 | 0.20 | 0.20 | 0.20 | 0.20 | 0.20 | 0.20 | 0.20 | 0.20 | 0.20 |
| E-3 | 0.75 | 0.75 | 0.75 | 0.75 | 0.75 | 0.75 | 0.75 | 0.75 | 0.75 | 0.75 | 0.75 | 0.75 | 0.75 |
| Properties | | | | | | | | | | | | | |
| MVR (260° C./ | 134 | 14 | 37 | 84 | 11 | 25 | 12 | 15 | 40 | 13 | 32 | 16 | 18 |
| 5 kg) [ml/ | | | | | | | | | | | | | |
| 10 min] | | | | | | | | | | | | | |
| Impact | 53 | n.g. | 70 | — | — | 148 | n.g. | n.g. | — | — | 125 | 142 | 156 |
| strength | | | | | | | | | | | | | |
| [kJ/m2] | | | | | | | | | | | | | |
| Vicat B120 | 130 | 141 | 135 | — | — | 137 | 142 | 141 | — | — | 136 | 140 | 140 |
| [° C.] | | | | | | | | | | | | | |
| ΔMVR (300° C./ | — | — | — | — | — | 74 | 5 | 14 | — | — | 58 | 9 | 22 |
| 15 min) [ml/ | | | | | | | | | | | | | |
| 10 min] | | | | | | | | | | | | | |
| Streaking | yes | Yes | no | — | — | yes | yes | no | — | — | yes | yes | no |
| at 280° C. | | | | | | | | | | | | | |

| | Components [parts by wt] | | | | | | | | | | | | |
|---|---|---|---|---|---|---|---|---|---|---|---|---|---|
| | 14 | | 16 | | 18 | | 20 | | 22 | | | | |
| | (Comp.) | 15 | (Comp.) | 17 | (Comp.) | 19 | (Comp.) | 21 | (Comp.) | 23 | 24 | 25 | 26 |
| A | 60 | 60 | 50 | 50 | 40 | 40 | 30 | 30 | 83 | 83 | 83 | 83 | 83 |
| B-1 | 30 | 30 | 40 | 40 | 50 | 50 | 60 | 60 | — | — | — | — | — |
| B-2 | — | — | — | — | — | — | — | — | 7 | 7 | 7 | 5.5 | 4 |
| B-3 | — | — | — | — | — | — | — | — | — | — | — | 1.5 | 3 |
| C | 10 | 10 | 10 | 10 | 10 | 10 | 10 | 10 | 10 | 10 | 10 | 10 | 10 |
| D-1 | — | 0.3 | — | 0.3 | — | 0.3 | — | 0.3 | — | 0.3 | — | — | — |
| D-2 | — | — | — | — | — | — | — | — | — | — | 0.3 | 0.3 | 0.3 |
| E-1 | 0.50 | 0.50 | 0.50 | 0.50 | 0.50 | 0.50 | 0.50 | 0.50 | 0.50 | 0.50 | 0.50 | 0.50 | 0.50 |
| E-2 | 0.20 | 0.20 | 0.20 | 0.20 | 0.20 | 0.20 | 0.20 | 0.20 | 0.20 | 0.20 | 0.20 | 0.20 | 0.20 |
| E-3 | 0.75 | 0.75 | 0.75 | 0.75 | 0.75 | 0.75 | 0.75 | 0.75 | 0.75 | 0.75 | 0.75 | 0.75 | 0.75 |
| Properties | | | | | | | | | | | | | |
| MVR (260° C./ | 44 | 21 | 50 | 27 | 56 | 31 | 70 | 37 | 11 | 7 | 9 | 11 | 11 |
| 5 kg) [ml/ | | | | | | | | | | | | | |
| 10 min] | | | | | | | | | | | | | |
| Impact | — | — | — | — | — | — | — | — | n.g. | n.g. | n.g. | n.g. | n.g. |
| strength | | | | | | | | | | | | | |
| [kJ/m2] | | | | | | | | | | | | | |
| Vicat B120 | — | — | — | — | — | — | — | — | 141 | 142 | 142 | 143 | 143 |
| [° C.] | | | | | | | | | | | | | |
| ΔMVR (300° C./ | — | — | — | — | — | — | — | — | 29 | 7 | 8 | 18 | 12 |
| 15 min) [ml/ | | | | | | | | | | | | | |
| 10 min] | | | | | | | | | | | | | |
| Streaking | — | — | — | — | — | — | — | — | no | no | no | no | no |
| at 280° C. | | | | | | | | | | | | | |

From Table 1 it can be seen that by adding small amounts of Brönsted acid compounds to talcum-filled, impact resistance-modified polycarbonate compositions, the thermal stability of such compositions in the range of the PC:ABS ratios according to the invention is improved in the compounding and processing, and the ductility (impact strength) and stability towards deformation under heat (Vicat B 120) are increased in a surprising manner. In particular, compositions with high polycarbonate contents as well as talcum-filled, non impact resistance-modified (ABS-free) polycarbonate compositions having high thermal stability (Examples 2, 3, 5, 7, 8 and 10) can be produced in this way. In particular, it is found from experience that such compositions with a high polycarbonate content prove to be particularly thermally unstable without the addition of these acids according to component D, already during the compounding and in the following molding processing (comparison Examples 1, 4, 6 and 9). Namely, by employing at least one Brönsted acid at a level of only 0.3 wt.-% it is possible to increase the thermal stability of the material towards deformation (Vicat B210) in an amount of up to 4 to 5° C., and in some cases even up to 11° C. It is also possible by employing at least one Brönsted acid at a level of only 0.3 wt.-%, to increase the impact strength of the polycarbonate composition by an amount of up to 25%, and in some cases even up to 32%.

The use of thermally stable acids such as terephthalic acid (component D-2) results in a further improvement in the processing stability compared to similar formulations in which acids are used that decompose under the thermal conditions of the compounding (that is, at temperatures of up to 200 C, and in some cases, up to 350 C). This is manifested in a reduction of the tendency to streak formation during processing in injection molding (compare respectively Examples 2 and 3, 7 and 8 and also 12 and 13).

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

All documents referred to herein are specifically incorporated herein by reference in their entireties.

As used herein and in the following claims, articles such as “the”, “a” and “an” can connote the singular or plural.

1. A composition comprising
A) 10 to 100 parts by weight, based on the total weight of components A and B, of polycarbonate, polyester carbonate or a mixture thereof,
B) 0 to 90 parts by weight, based on the total weight of components A and B, of a polymer which is at least one selected from the group consisting of graft polymer produced in an emulsion polymerisation process, graft polymer produced in a bulk polymerisation process, rubber-free vinyl homopolymer and rubber-free vinyl copolymer,
C) 7 to 30 wt. %, based on the total weight of the composition of talcum,
D) 0.01 to 1 wt. %, based on the total weight of the composition of a Brönstedt acid,
E) 0 to 20 wt. %, based on the total weight of the composition of at least one polymer additive,
wherein the composition is free of aromatic or partially aromatic polyesters,
wherein the sum of the wt. % of the components A and B in the total composition is calculated from the difference of 100 wt. % minus the sum of the wt. % of the components C, D and E, and
wherein the total composition comprises the sum of the wt. % of components A+B+C+D+E.

2. A composition according to claim 1, wherein
A) is present in an amount of 80 to 100 parts by weight, and
B) is present in an amount of 0 to 20 parts by weight.

3. A Composition according to claim 1, wherein
A) is present in an amount of 100 parts by weight, and
B) is present in an amount of 0 part by weight.

4. A composition according to claim 1, wherein component C comprises a talcum with an Al₂O₃ content <1.0 wt. %.

5. A composition according to claim 1, wherein component C comprises a talcum with a mean particle diameter d₅₀ of <2 μm.

6. A composition according to claim 1, wherein component E is at least one selected from the group consisting of flameproofing agents, anti-drip agents, lubricants and mold release agents, nucleating agents, antistatics, stabilisers, fillers, reinforcing substances other than talcum, dyes and pigments.

7. A composition according to claim 1, wherein component D comprises at least one compound selected from the group consisting of aliphatic or aromatic carboxylic acids, aliphatic or aromatic sulfonic acids, aliphatic or aromatic phosphonic acids, hydroxy-functionalised dicarboxylic acids, ortho-phosphoric acid, meta-phosphoric acid, boric acid, and acid salts of phosphoric acids.

8. A composition according to claim 7, wherein component D comprises at least one compound selected from the group consisting of benzoic acid, citric acid, oxalic acid, fumaric acid, mandelic acid, tartaric acid, terephthalic acid, isophthalic acid and p-toluenesulfonic acid.

9. A composition according to claim 1, wherein component D is an acid which is thermally stable and is not volatile when compounded and/or processed.

10. A composition according to claim 9, wherein component D) is at least one acid selected from the group consisting of terephthalic acid or acid salts of inorganic acids.

11. A composition according to claim 1, wherein component D comprises an acid that decomposes under thermal compounding, and further wherein at least one decomposition product can be formed, said decomposition product comprising (i) a product that is thermally stable and not volatile when compounded, and/or (ii) a product that has a boiling point below 150° C.,

12. A composition according to claim 11, wherein component D) is at least one acid selected from the group consisting of ortho-phosphoric acid, meta-phosphoric acid, boric acid and oxalic acid.

13. A Process for the production of a composition according to claim 11 comprising,
melting components A to E in a mixing device;
mixing components A to E at a temperature of 240° to 320° C., and
removing volatile decomposition products of component D that are formed by applying a vacuum of p_{Abs}.≦500 mbar.

14. A method for the production of a molded article comprising molding an article comprising a composition according to claim 1.

15. A molded article comprising a composition according to claim 1.

16. A molded article according to claim 15, where the molded article comprises a film, profiled section, housing part, structural part for commercial and utility vehicles or for the automobile sector, an internal structural part for track vehicles, ships, aircraft, buses and/or vehicle, a vehicle body part, a housing of electrical equipment containing a small transformer, a housing for information processing and transmission equipment, a housing and lining of medical equipment, a child's toy vehicle, a two-dimensional wall element, a housing for safety devices, a thermally insulated transporting container, a molded part for sanitaryware and/or a bath fitting, a cover grating for ventilation openings, and/or a shed for garden tools.

17. A molded article according to claim 15, wherein the molded article comprises a two-component structural part comprising
(i) a first component comprising a transparent or translucent polycarbonate molding composition and
(ii) a second component comprising a polycarbonate composition according to claim 1,
wherein the first component is completely or partly bonded to the second component.

18. A process for the production of a two-component structural part according to claim 17, comprising back injection molding the first component with the second component in an injection molding and/or injection compression molding process.

19. A two-component structural part that can be obtained by the process according to claim 18.

20. A window, glazing, lighting unit, optical lens, headlamp cover disc, decorative cover, diaphragm in a vehicle, monitor or display cover comprising a two-component structural part according to claim 17.

21. A composition according to claim 9 wherein said composition is stable at a temperature from 200° C. to 320° C.

22. A composition comprising a linear polycarbonate based on bisphenol A, an ABS polymer, optionally an SAN copolymer, talcum, either anhydrous citric acid or terephthalic acid, and pentaerythritol tetrastearate.

23. A talcum-filled, polycarbonate compositions comprising at least one Brönsted acid.

24. A polycarbonate composition of claim 23 wherein said Brönsted acid comprises terephthalic acid.

25. A polycarbonate composition of claim 23, wherein said composition is thermally stable at a temperature of up to 300° C., and has improved impact strength and/or Vicat B120 temperature as compared to a similar polycarbonate composition that does not comprise said Brönsted acid.

26. A polycarbonate composition of claim 23, wherein said composition has improved impact strength of at least +13% and/or an improved Vicat B120 of at least +4° C., as compared to a similar polycarbonate composition that does not contain said Brönsted acid.
